(19) United States
(12) Patent Application Publication
(10) Pub. No.: US 2021/0326758 A1
(43) Pub. Date: Oct. 21, 2021

(54) TECHNIQUES FOR AUTOMATICALLY AND OBJECTIVELY IDENTIFYING INTENSE RESPONSES AND UPDATING DECISIONS RELATED TO INPUT/OUTPUT DEVICES ACCORDINGLY

(71) Applicant: Intuition Robotics, Ltd., Ramat-Gan (IL)

(72) Inventors: Shay ZWEIG, Harel (IL); Alex KEAGEL, Tel Aviv (IL); Itai MENDELSOHN, Tel Aviv (IL); Roy AMIR, Mikhmoret (IL); Dor SKULER, Oranit (IL); Eldar RON, Tel Aviv (IL)

(73) Assignee: Intuition Robotics, Ltd., Ramat-Gan (IL)

(21) Appl. No.: 17/233,832

(22) Filed: Apr. 19, 2021

Related U.S. Application Data
(60) Provisional application No. 63/011,573, filed on Apr. 17, 2020.

(51) Int. Cl. G06N 20/00; G06N 3/04; G10L 15/22; G10L 25/63; G06K 9/00; G06K 9/62

(52) U.S. Cl. CPC G06N 20/00; G06N 3/04; G10L 15/22; G10L 2015/225; G06K 9/00315; G06K 9/6269; G10L 25/63

(57) ABSTRACT

A system and method for automatically and objectively identifying intense responses and updating decisions related to input/output devices. A method includes applying a machine learning model to an input dataset including data from sensors related to actions performed by a user in response to outputs caused via at least one input/output (I/O) device; identifying, based on output of the machine learning model, an intense response of the user; updating a decision-making model with respect to controlling the at least one I/O device based on the identified intense response; and executing at least one plan based on the updated decision-making model, wherein executing the at least one plan further comprises causing at least one output via the at least one I/O device.

### CROSS-REFERENCE TO RELATED APPLICATIONS

This application claims the benefit of U.S. provisional patent application No. 63/011,573 filed on Apr. 17, 2020, the contents of which are hereby incorporated by reference.

### TECHNICAL FIELD

The disclosure generally relates to digital assistants configured to control input/output devices and, more specifically, to updating a decision-making model of such a digital assistant based on identification of an intense negative user response.

### BACKGROUND

As manufacturers continue to improve electronic device functionality through the inclusion of processing hardware, users, as well as manufacturers themselves, may desire expanded feature sets to enhance the utility of the included hardware. Examples of technologies which have been improved, in recent years, by the addition of faster, more-powerful processing hardware include cell phones, personal computers, vehicles, and the like. As described, such devices have also been updated to include software functionalities which provide for enhanced user experiences by leveraging device connectivity, increases in processing power, and other functional additions to such devices. However, the software solutions described, while including some features relevant to some users, may fail to provide certain features which may further enhance the quality of a user experience.

Many modern devices, such as cell phones, computers, vehicles, and the like, include software suites which leverage device hardware to provide enhanced user experiences. Examples of such software suites include cell phone virtual assistants, which may be activated by voice command to perform tasks such as playing music, starting a phone call, and the like, as well as in-vehicle virtual assistants configured to provide similar functionalities. While such software suites may provide for enhancement of certain user interactions with a device, such as by allowing a user to place a phone call using a voice command, the same suites may fail to provide adaptive, customized functionalities, thereby hindering the user experience. As certain currently-available user experience software suites for electronic devices may fail to provide adaptive, customized functionalities, the same suites may be unable to learn, and adapt to, a user's preferences, thereby requiring a user to engage with non-preferred or non-ideal software suite executions across multiple instances, which may limit user experience quality.

Further, in addition to failing to provide adaptive, customized functionalities, the same user experience software suites for electronic devices may fail to include context-aware functionalities. Where such suites lack context-aware functionalities, the same suites may be unable to identify data concerning a user's environment, such as whether a user is riding in a vehicle with another passenger, as well as data concerning a user's preferences, such as whether a user enjoys or does not enjoy a particular podcast. Where electronic device user experience software suites fail to provide for context awareness and user preference detection, the same suites may fail to tailor the execution of software features to a user's preference or environment, thereby limiting the applicability of such software, as well as a user's enjoyment of an electronic device including such software.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for automatically and objectively identifying intense responses and updating decisions related to input/output devices accordingly. The method comprises applying a machine learning model to an input dataset including data from at least one sensor related to actions performed by a user in response to outputs caused via at least one input/output (I/O) device, wherein the machine learning model is trained to output anomalies in user behavior; identifying, based on output of the machine learning model, an intense response of the user, wherein the intense response of the user is an anomaly identified by the machine learning model; updating a decision-making model at least with respect to controlling the at least one I/O device based on the identified intense response; and executing at least one plan based on the updated decision-making model, wherein executing the at least one plan further comprises causing at least one output via the at least one I/O device.

Certain embodiments disclosed herein also include a non-transitory computer readable medium having stored thereon instructions for causing a processing circuitry to execute a process, the process comprising applying a machine learning model to an input dataset including data from at least one sensor related to actions performed by a user in response to outputs caused via at least one input/output (I/O) device, wherein the machine learning model is trained to output anomalies in user behavior; identifying, based on output of the machine learning model, an intense response of the user, wherein the intense response of the user is an anomaly identified by the machine learning model; updating a decision-making model at least with respect to controlling the at least one I/O device based on the identified intense response; and executing at least one plan based on the updated decision-making model, wherein executing the at least one plan further comprises causing at least one output via the at least one I/O device.

Certain embodiments disclosed herein also include a system for automatically and objectively identifying intense responses and updating decisions related to input/output devices accordingly. The system comprises: a processing circuitry; and a memory, the memory containing instructions that, when executed by the processing circuitry, configure the system to: apply a machine learning model to an input dataset including data from at least one sensor related to actions performed by a user in response to outputs caused via at least one input/output (I/O) device, wherein the machine learning model is trained to output anomalies in user behavior; identify, based on output of the machine learning model, an intense response of the user, wherein the intense response of the user is an anomaly identified by the machine learning model; update a decision-making model at least with respect to controlling the at least one I/O device based on the identified intense response; and execute at least one plan based on the updated decision-making model, wherein executing the at least one plan further comprises causing at least one output via the at least one I/O device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a system utilized for updating a decision-making model of a digital assistant based on identification of an intense negative user response, according to an embodiment.

FIG. 2 is a block diagram of a controller, according to an embodiment.

FIG. 3 is a flowchart illustrating a method for immediately updating a decision-making model of a digital assistant based on identification of an intense user response, according to an embodiment.

FIG. 4 is a flowchart illustrating a method for updating a decision-making model of a digital assistant based on identification of an intense negative user response, according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

The disclosed system and method provide for updating a decision-making model of a digital assistant based on identification of an intense negative or positive user response. A user response, to an action that has been performed by the digital assistant, is collected and analyzed. Based on a determination that an intense response is identified, features of the environment near the user are extracted and analyzed. Then, a root cause for the intense response of the user is determined. Based on the determined root cause, the decision-making model of the digital assistant is updated such that plans can be executed, such as, for example, for preventing undesirable actions of the digital assistant.

In an embodiment, intense responses are identified by applying a machine learning model trained to detect anomalies in user behavior. Thus, deviations from baseline user behavior as determined via the machine learning model are detected as intense reactions. In a further embodiment, it may be determined whether an intense response is negative or positive using one or more predetermined rules for determining whether a response is negative or positive.

The systems and methods disclosed herein provide an objective process for identification of intense responses and determination of root causes. Where a human observer would be limited by the subjectivity of the observer's own subjective perceptions regarding the intensity of the user response, the disclosed system and method provide for objective identification of intense responses based on anomaly detection. Further, the disclosed system and method provide for the objective isolation of root causes, including historical analysis, where a human observer may be limited to subjective identification of factors causing a user's current intense response. Accordingly, the disclosed system and method provide for improved objectivity in intense response detection and root cause determination.

In this regard, it has been identified that an intense reaction manifests as an anomaly in user behavior with respect to user actions that are observable via one or more sensors. Baseline user behavior may be learned using historical sensor data such that intense reactions may be identified by detecting anomalies in user behavior. This is different from a manual process which might be used by a human observer. Namely, the manual process would be to observe the user and identify actions that seem, to the human observer, to be intense positive or intense negative responses. Different human observers would reach different conclusions about what is intense based on their own subjective perceptions of “normal” behavior generally, for a particular user, or both.

As a non-limiting example, if a user's typical reaction to a digital assistant asking, “would you like to listen to the radio today” is a simple “no thank you,” an anomalous reaction may be a once-in-a-month response of “absolutely not, do not suggest that again.” Anomalous reactions may be detected by consideration of various user responses including, without limitation, words or phrases used, tone of voice, facial expression, body language, and the like, as well as various combinations thereof. In the embodiments disclosed herein, intense reactions are detected by comparison of collected user response data with historical and other, like, response data, providing for identification of anomalous responses as intense.

Where an intense response is identified as described, understanding the cause of the intense response may provide for reduction or elimination of similar intense responses in the future. The root cause of the intense response, or the factor causing the user to respond in an uncharacteristic or anomalous fashion, may be a factor of the user's environment, such as the weather, the time of day, or any combination thereof. In the embodiments disclosed herein, intense reaction root causes are identified by analysis of historical user response data, and other, like, response data. Such analysis may include comparison of response intensity with environmental factor measurements, as well as, across many such comparisons, isolation of environmental factors with high likelihoods of causing intense responses.

Further, where an intense response is identified, and where the corresponding root cause or causes are identified, adaptation of a digital assistant to account for the identified root cause may provide for the prevention of future intense responses. In the disclosed embodiments, a digital assistant is updated based on identification of intense responses, and corresponding root causes, to provide for reduction or elimination of future interactions between a user and a digital assistant, where such interactions may be predicted to include a user's intense response. Such adjustment of the digital assistant may provide for reduced aggravation for the user, and a more pleasant user experience.

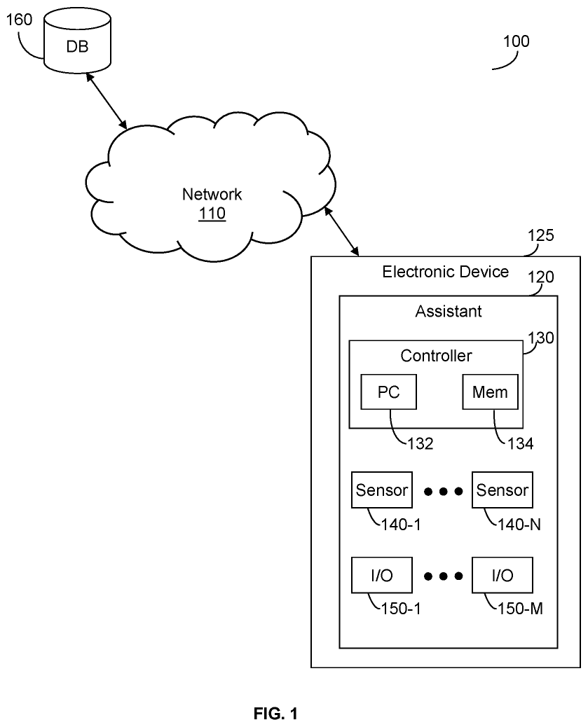

FIG. 1 is an example network diagram of a system 100 according to an embodiment. The system 100 includes a digital assistant 120 deployed on an electronic device 125. In some embodiments, the digital assistant 120 is further connected to a network, where the network 110 is used to communicate between different parts of the system 100. The network 110 may be, but is not limited to, a local area network (LAN), a wide area network (WAN), a metro area network (MAN), the Internet, a wireless, cellular or wired network, and the like, and any combination thereof.

In an embodiment, the digital assistant 120 may be connected to, or implemented on, the electronic device 125. The electronic device 125 may be, for example and without limitation, a robot, a social robot, a service robot, a smart TV, a smartphone, a wearable device, a vehicle, a computer, a smart appliance, and the like.

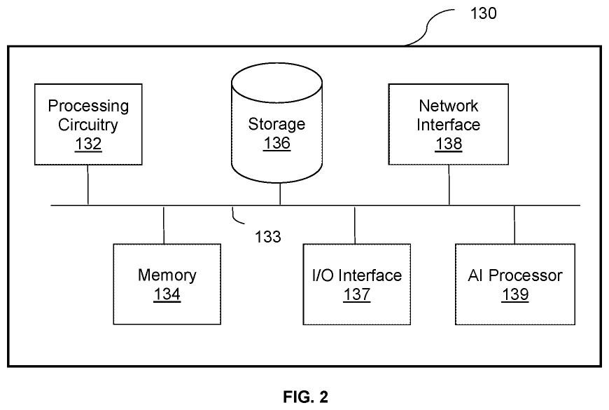

The digital assistant 120 includes a controller 130, explained in greater detail below in FIG. 2, having at least a processing circuitry 132 (PC) and a memory 134. The digital assistant 120 may further include, or be connected to, one or more sensors 140-1 to 140-N, where N is an integer equal to or greater than 1 (hereinafter referred to as “sensor” 140 or “sensors” 140 merely for simplicity) and one or more input/output (I/O) devices 150-1 to 150-M, where M is an integer equal to or greater than 1. The I/O devices 150 are at least configured to cause outputs that can be perceived by users in the outside world (i.e., the real world) and may include, but are not limited to, electro-mechanical elements, display units, speakers, and so on. In an embodiment, the I/O devices 150 may encompass sensors 140 as well.

The sensors 140 may include input devices, such as various sensors, detectors, microphones, touch sensors, movement detectors, cameras, and the like. Any of the sensors 140 may be, but are not necessarily, communicatively or otherwise connected to the controller 130 (such connection is not illustrated in FIG. 1 for the sake of simplicity and without limitation on the disclosed embodiments). The sensors 140 may be configured to sense signals received from one or more users, the environment of the user (or users), and the like. The sensors 140 may be positioned on, or connected to, the electronic device 125 (e.g., a vehicle, a robot, and so on). In an embodiment, the sensors 140 may be implemented as virtual sensors that receive inputs from online services, e.g., the weather forecast.

The digital assistant 120 is configured to use at least the controller 130 and the sensors 140 for updating a decision-making model of the digital assistant 120 based on identification of an intense response of a user, as further discussed hereinbelow. For example, the digital assistant 120 may use one or more artificial intelligence (AI) algorithms for identifying an intense negative response of the user, as further discussed hereinbelow. The algorithm may be also adapted to determine the impact of each feature of the user and of the user's environment (that is extracted from a collected dataset) on the intense negative response of the user. Thus, the AI algorithm may be utilized to determine the root cause for the intense negative response of the user and to update, respectively, the decision-making model of the digital assistant 120.

In one embodiment, the digital assistant 120 communicates with a database 160. The database 160 may be stored within the digital assistant 120 (e.g., within a storage device not shown), or may be separate from the digital assistant 120 and connected thereto via the network 110. The database 160 may be utilized for storing, for example, historical data about one or more users, historical identified features and their corresponding contribution level scores, and the like as further discussed hereinbelow with respect to FIG. 2.

It should be noted that the sensors 140 and the I/O devices 150 are depicted as components of the digital assistant 120 merely for example purposes, and that these components may be separate from, and in communication with, the digital assistant 120, without departing from the scope of the disclosure.

FIG. 2 shows a schematic block diagram of a controller 130 of an electronic agent, e.g., the digital assistant 120 of FIG. 1, according to an embodiment. The controller 130 includes a processing circuitry 132 that is configured to receive data, analyze data, generate outputs, and the like, as further described hereinbelow. The processing circuitry 132 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The controller 130 further includes a memory 134. The memory 134 may contain therein instructions which, when executed by the processing circuitry 132, cause the controller 130 to execute actions as further described hereinbelow. The memory 134 may further store therein information, e.g., data associated with one or more users, historical data, historical data about one or more users, historical identified features and their corresponding contribution level scores, and the like.

The storage 136 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

In an embodiment, the controller 130 includes a network interface 138 that is configured to connect to a network, e.g., the network 110 of FIG. 1. The network interface 138 may include, but is not limited to, a wired interface (e.g., an Ethernet port) or a wireless port (e.g., an 802.11-compliant Wi-Fi card) configured to connect to a network (not shown).

The controller 130 further includes an input/output (I/O) interface 137 configured to control the I/O devices 150 (shown in FIG. 1) that are connected to the digital assistant 120. In an embodiment, the I/O interface 137 is configured to receive one or more signals captured by sensors 140 of the digital assistant 120 and send them to the processing circuitry 132 for analysis. According to one embodiment, the I/O interface 137 is configured to analyze the signals captured by the sensors 140, detectors, and the like. According to a further embodiment, the I/O interface 137 is configured to send one or more commands to one or more of the I/O devices 150 for executing one or more plans (e.g., actions) of the digital assistant 120, as further discussed hereinbelow. For example, a plan may include suggesting that the user activate an auto-pilot system of a vehicle, playing jazz music by a service robot, preventing execution of other plans due to intense negative response of the user, and the like. According to a further embodiment, the components of the controller 130 are connected via a bus 133.

In an embodiment, the controller 130 further includes an artificial intelligence (AI) processor 139. The AI processor 139 may be realized as one or more hardware logic components and circuits, including graphics processing units (GPUs), tensor processing units (TPUs), neural processing units, vision processing units (VPUs), reconfigurable field-programmable gate arrays (FPGAs), and the like. The AI processor 139 is configured to perform, for example, machine learning based on sensory inputs received from the I/O interface 137, which receives input data, such as sensory inputs, from the sensors 140.

In an embodiment, the controller 130 is configured to collect, from a plurality of sensors (e.g., the sensors 140), a dataset including at least a first user response to at least one action that has been performed by the digital assistant 120 (e.g., an action caused via an output by one of the I/O devices 150). The dataset may further include data that is sensed with respect to the environment near the user. It should be noted that the user may be a user of a digital assistant, e.g., the digital assistant 120. The dataset may include, for example and without limitation, images, video, audio signals, and the like, as well as any combination thereof, which are captured in real-time or near-real-time when the first user response is identified. The user response may be a gesture, a facial expression, a sentence, a single word, a combination thereof, or the like. In an embodiment, the dataset may further include historical data about the user, data from one or more web sources, and so on.

As indicated hereinabove, the collected dataset may include data that is related to the environment near the user. Such data may indicate, for example, the temperature outside the user's house or vehicle, traffic conditions, noise levels, the number of people are located in close proximity to the user, and the like, as well as any combination thereof. In an embodiment, at least a portion of the collected dataset may be collected using a plurality of sensors (e.g., the sensors 140), which are communicatively connected to the digital assistant 120.

In an embodiment, the controller 130 is configured to apply at least a first algorithm, such as a machine learning algorithm, to the collected dataset. The at least a first algorithm may be adapted to determine, in real-time or near-real-time, whether an intense negative response of the user is identified. The determination may be achieved based on analysis of the collected dataset. The analysis of the dataset may be performed using, for example and without limitation, one or more computer vision techniques, audio signal processing techniques, machine learning techniques, and the like, as well as any combination thereof.

In an embodiment, the controller 130 is configured to apply a machine learning model via the AI processor 139 to detect anomalies in user behavior. The machine learning model is trained based on historical user behavior data in order to learn baseline user behavior which can be utilized to identify anomalous user behavior. When an anomaly is identified, it is determined that an intense response has occurred. As noted above, identifying intense responses via detection of anomalies using machine learning allows for objectively determining when an intense response has occurred.

In a further embodiment, when an intense response has been identified, it may be determined whether the intense response is an intense negative response using one or more predetermined rules for determining whether a response is negative or positive with respect to user actions such as, but not limited to, speaking certain words or phrases, making certain facial expressions or gestures, and the like, as well as any combination thereof.

An intense negative response of the user may be represented by, for example and without limitation, certain predetermined negative words, negative phrases, slang, gestures, facial expressions, or the like, as well as a combination thereof, indicating that the user is not satisfied with the action made by the digital assistant 120 and, therefore, that the user does not want this action to continue, nor to be executed in the future. For example, an intense negative reaction may be a response from which it is observed that the user becomes angry right after the digital assistant 120 suggests that the user listen to jazz music while the user is seated in her/his vehicle.

According to another embodiment, an intense positive response may be identified. That is, the system and methods described above and below may be used for updating, in near real-time, a decision-making model of the digital assistant 120 based on identification of an intense positive response of a user. It should be noted that, while a regular positive response may be, for example: “yes,” “yes, please,” “sounds like a good idea”, or the like, and may indicate that the user accepts the suggestion made by the digital assistant 120, an intense positive response may include more passionate responses. Such passionate responses may be, for example: “yes, definitely!” “sounds great!,” and on the like. It should be noted that, in both cases, gestures and facial expressions, as well as verbal inputs, may facilitate determination of whether the positive response is an intense positive response or just a regular positive response.

It should be noted that not every negative response of the user shall be classified as an intense negative response. While a regular negative response may be, for example: “no,” “no, thank you,” “sounds like a good idea, please remind me later,” or the like, and may indicate that the user is not willing to accept the suggestion made by the digital assistant 120, an intense negative response may include a more severe response. Such a severe response may be, for example, “definitely not,” “certainly did not ask you to listen to music,” and the like. In accordance with the disclosed embodiments, only behaviors which are anomalous are analyzed to determine whether they are negative or positive and, accordingly, intense negative and intense positive responses only include responses which are anomalous.

In an embodiment, an intense response may be detected by applying the machine learning model via the AI processor 139 to detect intense responses based on predetermined words, phrases, sentences, facial expressions, actions, and the like, as well as any combination thereof.

In an embodiment, upon determination that at least one intense negative response of the user was identified, the controller 130 extracts, from the dataset, a set of features about the environment the user is in and about outputs caused via one or more I/O devices which might have prompted the intense response. The set of features may refer to objects, such as, as examples and without limitation, the amount of people near the user, people's identities, traffic conditions, and the like, as well as any combination thereof. The extracted set of features may also refer to the weather parameters, the time of day, and the like. For example, the extracted set of features may indicate that the user is seated in a vehicle (in which the electronic device 125 operates), that another person is seated next to the user, that the other person is the user's daughter, that the time is 7:46 AM, and that the weather is bad.

In an embodiment, the controller 130 is configured to apply at least a second algorithm, such as a machine learning algorithm, to the set of features. The at least a second algorithm may be adapted to determine which feature or combination of features has the highest probability for causing the intense negative response of the user. In an embodiment, a single feature may have the highest probability for causing the negative response of the user. According to another embodiment, a combination of several features may have the highest probability for causing the negative response of the user. For example, when an intense negative response of a user, where the user is currently driving a vehicle, is identified, three extracted features (among other features) may indicate that it is rainy, that traffic is bad, and that two children are arguing at the back seat of the vehicle. It should be noted that additional features may be identified and extracted, such as, as examples and without limitation, the temperature inside the vehicle, the expected travel time, and the like. According to the same example, the second algorithm may determine that the combination of the aforementioned three features (rainy outside, traffic is bad, and children are arguing), has the highest probability for causing the intense negative response of the user.

According to another embodiment, the controller 130 may be configured to determine, for each feature of the set of features, a contribution level score. The contribution level score represents the contribution of each extracted feature to the intense negative response of the user. The contribution level score may be implemented as a number from “1” to “10,” where “1” is the lowest and “10” is the highest number representing the highest contribution of a certain feature to an intense negative response of the user. In an embodiment, the contribution level score of each extracted feature may be determined by applying the at least a second algorithm to the extracted set of features. That is, the at least a second algorithm may be adapted to determine a corresponding contribution level score for each extracted feature to the intense negative response of the user. For example, after receiving an intense negative response from the user to a suggestion, made by the digital assistant 120, to play jazz music, the features, which are extracted from the dataset, may indicate that the user is cooking in the kitchen, that five other people are identified next to the user, and that the time is 6 PM. According to the same example, the contribution level score (representing the influence of each feature on the intense negative user response) of each feature is determined as follows: contribution level score of cooking: 1, contribution level score of the presence of five people near the user: 9, contribution level score of the particular time of day: 5. In an embodiment, each contribution level score is determined based on analysis of all of the extracted features. That is, the contribution level score of a first feature may be affected by a second, a third, and other, like extracted features.

In an embodiment, the controller 130 determines at least a root cause for the intense negative response of the user based on determination of the one or more features having the highest probability for causing the intense negative response of the user. That is, upon determining that the highest probability for causing the intense negative response of the user is associated with a specific feature or a combination of features, the root cause is determined based on the one or more features having the highest probability score.

According to a further embodiment, determination of the root cause may be achieved using the contribution level score of each extracted feature. That is, upon determining a corresponding contribution level score for each feature, the controller 130 determines which feature (or combination of features) has caused the intense negative response of the user. In an embodiment, the determination of the root cause may be achieved using a predetermined set of rules. A set of rules, or a rule, may indicate that, e.g., all extracted features having contribution level scores that are above 6 (out of 10) should be classified as a root cause for the intense negative response of the user. For example, after receiving an intense negative response from the user to a suggestion to play jazz music, it is determined that the contribution level score of cooking is 1 out of 10, that the contribution level score of the presence of five people near the user is 9 out of 10, and that the contribution level score the particular time of day is 5 out of 10. According to the same example, the controller 130 may be configured to determine (e.g., using the at least one algorithm) that the root cause of the intense negative response of the user is the presence of the five people near the user. According to another example, the controller 130 may determine that the root cause for the intense negative response of the user is the presence of the five people and the fact that the time is 6 PM.

It should be noted that determination of the root cause, as well as determination of the highest probability and/or the contribution level score of each feature, may be also achieved using historical data that is previously gathered about the user. For example, the user may be very positive to suggestions provided by the digital assistant 120 to listen to Jazz music during morning hours, so when an intense negative response is identified after suggesting that the user listen to jazz music at 10 PM, the feature that may get the highest probability for causing the intense negative response of the user may be the time of day.

In an embodiment, the controller 130 updates a decision-making model of the digital assistant 120 based on determination of the at least a root cause. In a further embodiment, the controller 130 may be configured to update the decision-making model to avoid causing certain activities (e.g., by avoiding causing certain outputs via I/O devices) when it is determined that a user had an intense reaction to those activities. In yet a further embodiment, such activities may be avoided when the intense reaction is determined to be an intense negative reaction. A decision-making model of the digital assistant 120 may include one or more artificial intelligence (AI) algorithms that are utilized for determining the actions to be performed by the digital assistant 120. Thus, when a root cause is determined, the root cause is fed into the decision-making model, thereby allowing the decision-making model to execute plans (e.g., actions) which suit the determined root cause that caused the intense negative response of the user. For example, when it is determined that the root cause for the intense negative response was the presence of other people near the user, the decision-making model is updated with the determined root cause. Therefore, a plan may be executed by the controller 130 for preventing identical and/or similar immediate suggestions and/or future suggestions when the user has company.

In an embodiment, determination of the root cause may be used for updating the decision-making model for more than just one plan or action. That is, although the root cause is determined with respect to a specific action, the determination may affect other future actions the digital assistant 120 may execute. For example, a root cause for an intense negative response of the user may be related to a suggestion to listen to a podcast. According to the same example, the root cause may be rainy weather and the fact that the user's children are in the vehicle near the user when the user is driving. According to the same example, the same root cause may be used by the controller 130 for preventing a future plan or action that suggests to listen to music when it is raining, and the user's children are in the vehicle near the user when the user is driving. That is, the controller 130 may use the determined root cause for updating the decision-making model of the digital assistant 120 with respect to all actions or plans that may be affected by the same root cause.

In an embodiment, updating the decision-making model of the digital assistant 120 with the at least one root cause occurs upon determination that the root cause is determined to be above a predetermined certainty threshold value. The predetermined certainty threshold value may indicate, for example, that a root cause may be determined only if the contribution level score of at least one feature is above 6 out of 10.

According to one embodiment, upon determination that the predetermined certainty threshold value was not crossed, the controller 130 may be configured to generate a question to be presented by the digital assistant 120 to the user, using, for example, one or more resources, e.g., the I/O devices 150. According to one embodiment, the at least one question may be generated based on analysis of the collected dataset. It should be noted that the question may be generated and presented to the user only when the circumstances, as sensed by at least one sensor, provide for asking the user such a question without causing an unpleasant user experience. In an embodiment, the controller 130 may be configured to collect at least a second user response with respect to the presented question. Collection of the second user response may be achieved using the one or more sensors, such as the sensors 140. According to a further embodiment, the decision-making model of the digital assistant 120 is updated with the second user response. For example, after receiving an intense negative response from the user to a suggestion to play a podcast, it is determined that the there is no certainty regarding the root cause. According to the same example, the digital assistant 120 (e.g., the controller 130) may generate a question such as: “what was the reason for your refusal to listen to the podcast earlier?” and present it to the user. It should be noted that the question may be presented to the user after the circumstances around the user are changed. The digital assistant 120 may detect such change in circumstances by constantly analyzing dataset that is collected and sensed by the sensors 140.

With the system and method described above, the digital assistant may be able to learn faster the user's requirements and commands by identifying intense negative responses of the user. The intense negative response may be used for extinguishing an undesirable action in real-time, preventing execution of similar plans or actions in the future after a short learning phase (e.g., only one incident for which an intense negative response was collected), and so on.

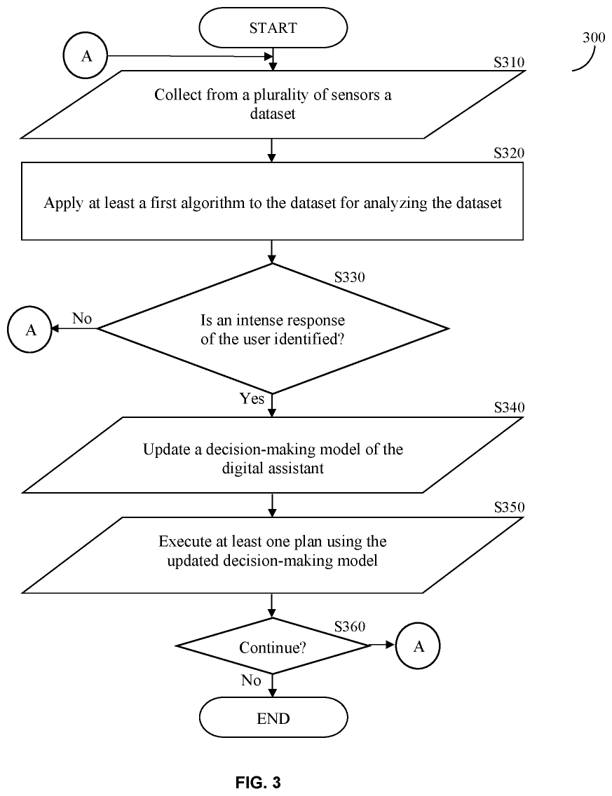

FIG. 3 shows a flowchart 300 of a method for immediately updating a decision-making model of a digital assistant based on identification of an intense response of a user, according to an embodiment. The method described herein may be executed by the controller 130 that is further described hereinabove with respect of FIG. 2.

At S310, a dataset is collected. The dataset may be indicative of at least a first user response to an action performed by the digital assistant. The dataset may include one or more user response data features, where user response data features may be, as examples and without limitation, words, phrases, sentences, facial expressions, actions, and the like, as well as any combination thereof. The dataset further includes at least environmental data that is sensed near the user. The dataset may be collected using one or more sensors, e.g., the sensors 140.

At S320, at least one algorithm (e.g., a machine learning algorithm) is applied to the dataset. The at least one algorithm is adapted to determine, in real-time or near-real-time, based on analysis of the dataset, whether an intense response of the user is identified. The intense response may be an intense negative response or an intense positive response as further described hereinabove with respect to FIG. 2.

In an embodiment, the at least one algorithm includes at least a machine learning algorithm configured to apply a machine learning model which is trained to identify anomalous user behavior. To this end, such a machine learning model is trained using a training data set including training data related to user actions in response to various external stimuli and, more specifically, external stimuli related to outputs caused by a digital assistant (e.g., outputs caused via the I/O devices 150 by the digital assistant 120, FIG. 1).

Determining whether an intense response of the user is identified may include, without limitation, comparing one or more user response data features as collected at S310, with one or more pre-defined sources of response information (e.g., repositories, dictionaries, etc.), comparing one or more user response data features with previously-collected user response data features, and analyzing one or more user response data features in view of one or more environmental data features.

Where, at S320, determining whether an intense response is identified includes comparing a collected user response data feature with various sources of pre-defined response information, the relevant collected user response data feature may be a word, phrase, sentence, gesture, action, facial expression, or the like. Further, the various sources of pre-defined response information may be various dictionaries, repositories, or the like, which may include one or more user responses, such as pre-defined words, phrases, facial expressions, or the like. The various sources of pre-defined response information may include one or more data labels, tags, or other, like, identifying data features, providing for correlation of each pre-defined user response included in a source as, as examples and without limitation, an intense negative response, an intense positive response, a neutral response, or the like. Further, a source of pre-defined response information may be stored in the database 160, or another, like, data storage device, component, or system.

Further, during determination by comparison of collected response data features with pre-defined response data, the one or more collected user response data features may be compared with one or more data features included in the various sources of pre-defined response information. Where a match is detected between a user response data feature and a pre-defined response data feature, the matching user response may be tagged, labeled, or otherwise described using the descriptor applicable to the corresponding pre-defined response. Further, such checking by comparison may include a similar comparison of a compound data feature, such as a spoken phrase and a facial expression, with a source of corresponding pre-defined compound response information. As an example, where a user's response to a specific song playing on a playlist is to say “great, I love this song,” checking by comparison may include comparing the user's spoken phrase, “great, I love this song,” with a dictionary of pre-defined response phrases. Where, according to the same example, the phrase “great, I love this song” is associated, in the dictionary, with a positive response, checking by comparison may include detecting, based on the user's spoken phrase, that the user has a positive response to the specific song.

Where, at S320, determination of whether an intense negative response of the user is identified includes comparison of one or more user response data features, collected at S310, with previously-collected user response data features, user response data, as collected at S310, may be compared with previously-collected response data. The previously-collected response data may be stored in one or more storage or memory devices, components, or systems, such as the database 160, and may include various user response data features, such as a user's spoken phrases or facial expressions, as well as one or more corresponding indicator. The indicators may describe the previously-collected response data as relevant to, as examples and without limitation, an intense negative response, an intense positive response, or the like. Further, checking based on previous responses may include comparing the one or more collected user response data features with the various previously-collected data features, and, where a match is identified, identifying a user's collected response based on the identifier corresponding to the matching previously-collected response.

As an example, where a user's response to a suggestion that the user listen to a specific podcast is to say “no, don't ever suggest that again,” the user's response phrase may be compared to a dictionary, or other, like, source, including the user's previously-collected responses. Where, according to the same example, the phrase “no, don't ever suggest that again,” is included in the dictionary of previously-collected user responses, and is associated with an intense negative reaction, checking, by the comparison described, may indicate an intense negative reaction to the suggestion that the user listen to the specific podcast.

In an embodiment, checking based on previous responses may include application of one or more machine learning (ML) models, where the applied ML models may be configured to identify anomalous responses. The ML models may be trained models, where model training may include training the ML models to identify, within sets of historic user response data, user responses which deviate from one or more “normal” or anticipated responses. Application of the one or more ML models may include analysis, via the models, of various collected user responses, and, based on such analysis, identification of user responses which deviate from the described “normal” or anticipated responses. Where such anomalous user responses are detected, the responses may be, at S330, identified as intense responses.

Further, where determining whether an intense negative response of the user is identified includes analysis of user response data features in view of environmental data features, user response and intensity, identified as described herein, may be subsequently adjusted in view of one or more environmental data features. Environmental data features, as may be collected at S310, may include data features concerning a user's environment, including, without limitation, light levels, time of day, weather conditions, and the like, as well as any combination thereof. Analysis in view of environmental data may include adjusting one or more user responses, response intensities, or both, based on environmental conditions. As an example, where environmental data indicates that a user was involved in a car accident, a user's intense negative response, as determined based on the collected user response data, may be adjusted to a regular negative response, indicating that, under normal circumstances, the user would have only a regular user response, and accounting for the added negative sentiment caused by the car accident.

At S330, it is checked whether an intense response of the user is identified and, if so, execution continues with S340; otherwise, execution continues with S310. In an embodiment, an intense response is identified when an anomaly is output by the machine learning model.

At S340, a decision-making model of the digital assistant (e.g., the digital assistant 120) is updated upon determination that an intense response was identified. The update may include information regarding the user's intense response and the circumstances that led to the intense response. It should be noted that the circumstances may be determined by analyzing the collected dataset.

At S350, at least one plan is executed using the updated decision-making model. The plan may be for example, preventing execution of a plan or an action, activating a silent mode for a predetermined period of time, and the like. At S360 it is checked whether to continue the operation and, if so, execution continues with S310, otherwise; execution terminates.

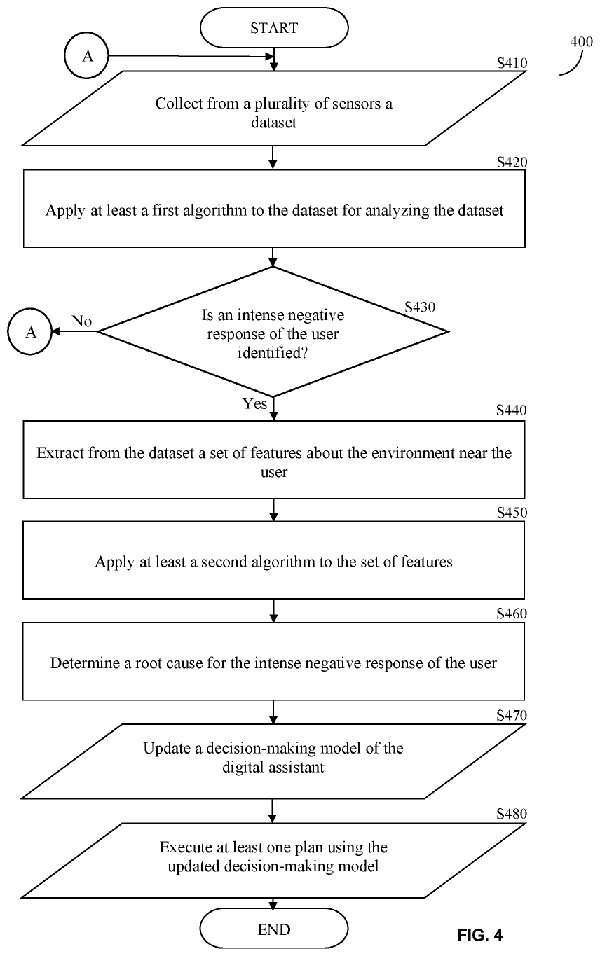

FIG. 4 shows a flowchart 400 of a method for updating, in near-real-time, a decision-making model of a digital assistant based on identification of an intense negative response of a user, according to an embodiment. The method described herein may be executed by the controller 130 that is further described hereinabove with respect to FIG. 2.

At S410, a dataset, indicating at least a first user response to an action performed by the digital assistant, is collected. The dataset may include one or more user response data features, where user response data features may be, as examples and without limitation, words, phrases, sentences, facial expressions, actions, and the like, as well as any combination thereof. The dataset further includes at least environmental data that is sensed near the user. The dataset may be collected using one or more sensors (e.g., the sensors 140).

At S420, at least one first algorithm (e.g., a machine learning algorithm) is applied to the dataset. The at least one first algorithm is adapted to determine in real-time or near-real-time, based on analysis of the dataset, whether an intense negative response of the user is identified. More specifically, in an embodiment, the at least one first algorithm includes a machine learning algorithm configured to detect anomalous user behavior by applying a machine learning model and an algorithm for applying one or more predetermined rules in order to determine whether each detected anomaly representing an intense response indicates an intense negative response or an intense positive response.

Determining whether an intense negative response of the user is identified may include, without limitation, one or more analyses, including analyses similar or identical to those described with respect to S320 if FIG. 3, above. Determination, at S420, may further include application of one or more ML models, as described with respect to S320, to determine whether a user response is anomalous and, where an anomalous response is detected, determining the anomalous response to be an intense response.

At S430, it is checked whether an intense negative response of the user is identified and, if so, execution continues with S440; otherwise, execution continues with S410.

At S440, a set of features about the environment near the user is extracted from the dataset upon determination that at least one intense negative response of the user is identified.

At S450, at least a second algorithm (e.g., a machine learning algorithm) is applied to the extracted set of features. The at least a second algorithm is adapted to determine one or more features of the set of features having a highest probability for causing the intense negative response of the user.

The second algorithm, as applied to the determination of features having the highest probability of causing an intense negative response, may be a feature isolation algorithm, providing for identification of per-feature intense response likelihoods based on historical response data. Such features may be sensor data, including environmental data, as well as other, like, data. The second algorithm may be configured to compare a user's historical response data and to, for the various user response data sets compared, identify the features included in each data set. The second algorithm may further be configured to compare response intensity for each data set, such as whether a response included in a data set is an intense response, and to identify features which are relevant to intense responses, as well as features which are not relevant to intense responses.

The second algorithm may be further configured to identify one or more contribution level scores for the identified features, where contribution level scores are scores representing the contribution of the corresponding feature to a user's intense response. Further, a contribution level score may indicate the likelihood that, in the presence of the corresponding feature, an intense user response will occur.

As an example, the second algorithm may be configured to identify features having the highest probability of causing an intense response, where the user provides an intense negative response to a suggestion to listen to a specific song. Where the user provides the intense negative response while driving, the second algorithm may be configured to analyze previous user response data, where such previous user response data is limited to data collected while driving. Analysis of previous while-driving data may indicate that the user tends to provide intense responses to song-change suggestions when the user is already listening to another song, when the user is driving with passengers in the car, and when the user is driving in the snow. Further, analysis of historic data may indicate that the user tends to provide non-intense responses to song-change suggestions when the user is driving at any speed, when the user is driving at any time of day, and when the user is driving in any region. Accordingly, for the same example, the second algorithm may be configured to apply a high contribution level score to sensor data indicating that music is already playing, to data indicating that other users are in the car, and to data indicating that the current weather condition is snow. Further, for the same example, the second algorithm may be configured to apply a low contribution level score to sensor data regarding vehicle speed, time of day, and location.

Further, in addition to historical data regarding a given user, the second algorithm may be configured to identify features, and contribution level scores thereof, based on historical data of one or more similar users. Historical data of one or more similar users may be identified and selected for analysis based on one or more common characteristics. Such common characteristics may include, as examples and without limitation, age, location, preferences, and the like, as well as any combination thereof. As an example, where a user is a thirty-year-old living in California, the second algorithm may be configured to, for an intense reaction, identify features, and corresponding contribution level scores, based on one or more historic user reaction data sets collected for other thirty-year-olds living in California.

In an additional embodiment, analysis of historical user response data, analysis of historical response data for other, similar users, may further include application of an intense response identification model or analysis to the various relevant historical data sets. The applied intense response identification model or analysis may be similar or identical to that described with respect to FIG. 3, above, and may be configured to identify a response intensity status, such as intense or not intense, for a data set for which no response intensity status is known. Further, according to the same embodiment, execution of S450 may include one or more analyses, as described hereinabove, which may be executed based on the identified response intensity statuses of the various historic datasets.

At S460, at least a root cause for the intense negative response of the user is determined based on determination of the one or more features having the highest probability for causing the intense negative response of the user. The root cause may be determined by analysis of the various contribution level scores identified at S450, including by identification of the feature or features corresponding to the highest identified contribution level score as the root cause. Further, in an embodiment, a root cause may be identified as each feature corresponding to a contribution level score exceeding a pre-defined or user-defined threshold.

At S470, a decision-making model of the digital assistant 120 is updated with the root cause, as further discussed hereinabove with respect to FIG. 2.

At S480, at least one plan is executed using the updated decision-making model.

The plan may be, for example, preventing execution of other plans or actions, activating a silent mode for a predetermined period of time, and the like, as well as any combination thereof.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for automatically and objectively identifying intense responses and updating decisions related to input/output devices accordingly, comprising:
applying a machine learning model to an input dataset including data from at least one sensor related to actions performed by a user in response to outputs caused via at least one input/output (I/O) device;
identifying, based on output of the machine learning model, an intense response of the user;
updating a decision-making model at least with respect to controlling the at least one I/O device based on the identified intense response; and
executing at least one plan based on the updated decision-making model, wherein executing the at least one plan further comprises causing at least one output via the at least one I/O device.

2. The method of claim 1, wherein the machine learning model is trained to output anomalies in user behavior.

3. The method of claim 1, wherein the intense response of the user is an anomaly identified by the machine learning model.

4. The method of claim 1, wherein the intense response is at least one of: an intense negative response, and an intense positive response.

5. The method of claim 4, wherein the output by the machine learning model is determined based on at least one first action of the actions performed by the user, wherein identifying the intense response of the user further comprises:
determining whether the at least one first action represents a negative response or a positive response.

6. The method of claim 5, wherein whether the at least one first action represents a negative response or a positive response is determined based on at least one of: at least one word spoken by the user, at least one facial expression made by the user, and at least one gesture made by the user.

7. The method of claim 1, further comprising:
determining a root cause of the intense response of the user, wherein the decision-making model is updated further based on the determined root cause.

8. The method of claim 7, wherein the determined root cause is at least one output caused via the at least one I/O device, wherein the decision-making model is updated to avoid causing the at least one output via the at least one I/O device.

9. The method of claim 7, wherein determining the root cause of the intense response of the user further comprises:
analyzing a plurality of features including at least one output feature and at least one environment feature, wherein the determined root cause includes at least one of the plurality of features, wherein each output feature indicates an output caused via the at least one I/O device, wherein each environment feature indicates an aspect of an environment the user is in.

10. The method of claim 9, wherein determining the root cause of the intense response of the user further comprises:
determining a contribution level score for each of the plurality of features, wherein the root cause is determined based on the determined contribution level scores.

11. The method of claim 10, wherein the determined root cause includes each feature of the plurality of features for which the determined contribution level score is above a threshold.

12. A non-transitory computer readable medium having stored thereon instructions for causing a processing circuitry to execute a process, the process comprising:
applying a machine learning model to an input dataset including data from at least one sensor related to actions performed by a user in response to outputs caused via at least one input/output (I/O) device;
identifying, based on output of the machine learning model, an intense response of the user;
updating a decision-making model at least with respect to controlling the at least one I/O device based on the identified intense response; and
executing at least one plan based on the updated decision-making model, wherein executing the at least one plan further comprises causing at least one output via the at least one I/O device.

13. A system for automatically and objectively identifying intense responses and updating decisions related to input/output devices accordingly, comprising:
a processing circuitry; and
a memory, the memory containing instructions that, when executed by the processing circuitry, configure the system to:
apply a machine learning model to an input dataset including data from at least one sensor related to actions performed by a user in response to outputs caused via at least one input/output (I/O) device;
identify, based on output of the machine learning model, an intense response of the user;
update a decision-making model at least with respect to controlling the at least one I/O device based on the identified intense response; and
execute at least one plan based on the updated decision-making model, wherein executing the at least one plan further comprises causing at least one output via the at least one I/O device.

14. The system of claim 13, wherein the machine learning model is trained to output anomalies in user behavior.

15. The method of claim 13, wherein the intense response of the user is an anomaly identified by the machine learning model.

16. The system of claim 13, wherein the intense response is at least one of: an intense negative response, and an intense positive response.

17. The system of claim 16, wherein the output by the machine learning model is determined based on at least one first action of the actions performed by the user, and wherein the system is further configured to:
determine whether the at least one first action represents a negative response or a positive response.

18. The system of claim 17, wherein whether the at least one first action represents a negative response or a positive response is determined based on at least one of: at least one word spoken by the user, at least one facial expression made by the user, and at least one gesture made by the user.

19. The system of claim 13, wherein the system is further configured to:
determine a root cause of the intense response of the user, wherein the decision-making model is updated further based on the determined root cause.

20. The system of claim 19, wherein the determined root cause is at least one output caused via the at least one I/O device, wherein the decision-making model is updated to avoid causing the at least one output via the at least one I/O device.

21. The system of claim 19, wherein the system is further configured to:
analyze a plurality of features including at least one output feature and at least one environment feature, wherein the determined root cause includes at least one of the plurality of features, wherein each output feature indicates an output caused via the at least one I/O device, wherein each environment feature indicates an aspect of an environment the user is in.

22. The system of claim 21, wherein the system is further configured to:
determine a contribution level score for each of the plurality of features, wherein the root cause is determined based on the determined contribution level scores.

23. The system of claim 22, wherein the determined root cause includes each feature of the plurality of features for which the determined contribution level score is above a threshold.
